(19) United States
(12) Patent Application Publication
(10) Pub. No.: US 2013/0007773 A1
(43) Pub. Date: Jan. 3, 2013

(54) SYSTEMS, METHODS, APPARATUSES, AND COMPUTER PROGRAM PRODUCTS FOR FACILITATING INTEGRATION OF THIRD PARTY TECHNOLOGY WITH A DATABASE

(76) Inventor: Steven Scott Guilford, Los Angeles, CA (US)

(21) Appl. No.: 13/170,901

(22) Filed: Jun. 28, 2011

(51) Int. Cl. G06F 9/46

(52) U.S. Cl. 719/328

(57) ABSTRACT

Methods, apparatuses, and computer program products are provided for facilitating integration of third party technology with a database. A method may include enqueueing, in a message queue selected from one or more message queues implemented in a database, a message including an indication of a function of a third party technology application programming interface corresponding to a call from a user application. The method may further include dequeueing the message from the selected message queue. The method may additionally include causing, based at least in part on the indication included in the dequeued message, the function of the third party technology application programming interface to be called. Corresponding apparatuses and computer program products are also provided.

### TECHNOLOGICAL FIELD

Embodiments of the present invention relate generally to computing technology and, more particularly, relate to systems, methods, apparatuses, and computer program products for facilitating integration of third party technology with a database.

### BACKGROUND

In the modern computing era, the usage of computing devices has become virtually ubiquitous among consumers of nearly all socioeconomic backgrounds. Many consumers regularly use mobile computing devices, such as smart phones and tablet computers. Many of these mobile computing devices run user applications, which may be used to control functionality found on third party devices. For example, some smart phones now run applications enabling a user to control electronics, home appliances, and/or the like remotely. Similarly, user applications may be used in industrial systems to control functions of third party industrial machines.

However, current architectures and methods for controlling third party technology from a user application generally suffer from delay that may occur in propagating commands, such as over a network, from the user application to an interface for controlling third party functionality. Further, current architectures and methods are generally not hardware or interface agnostics. Accordingly, a specific user application and/or specific application programming interface for a third party function or device often have to be developed for each platform that may be used for controlling the third party technology. Moreover, current architectures and methods for controlling third party technology that are agnostic to hardware or interface may not be able to take advantage of all of the functions and procedures available from an underlying platform, as current generalized agnostic solutions are generally limited to only using those functions and procedures that are common to all platforms on which the architecture may be implemented,

### BRIEF SUMMARY OF SOME EXAMPLES OF THE INVENTION

Systems, methods, apparatuses, and computer program products are provided herein for facilitating integration of third party technology with a database. Some example embodiments disclosed herein may provide several advantages to computing device users, computing devices, and application developers. In this regard, some example embodiments enable the integration of a third party technology into a database. Accordingly, functionalities of a database may be leveraged to facilitate inter-process communication enabling the control of a third party technology via a user application through the database.

In this regard, some example embodiments leverage a database message queue functionality providing buffered delivery of messages through the database to facilitate inter-process communication between a user application and a third party technology application programming interface (API). Accordingly, by integrating a third party technology API with a database, this message queue functionality is leveraged in some example embodiments to provide substantially real-time (e.g., substantially instantaneous) exchange of information between a user application and the third party technology API.

Further, some example embodiments advantageously allow the development and usage of user applications and/or third party technology interface APIs that are platform agnostic. In this regard, the user application and/or third party technology API of some example embodiments may be unaware of the database used to facilitate inter-process communication. In this regard, some example embodiments provide an interface between the user application and the database that may hide the actual database implementation from the user application and enable the user application to be agnostic to the underlying database platform. Similarly, some example embodiments provide an interface between the database and the third party technology API that may hide the actual database implementation from the third party technology API, such that the third party technology API may be agnostic to any database used to facilitate inter-process communication between the third party technology API and a user application.

In a first example embodiment, a method is provided. The method of this example embodiment may comprise enqueueing, in a message queue selected from one or more message queues implemented in a database, a message including an indication of a function of a third party technology application programming interface corresponding to a call from a user application. The method of this example embodiment may further comprise dequeueing the message from the selected message queue. The method of this example embodiment may also comprise causing, based at least in part on the indication included in the dequeued message, the function of the third party technology application programming interface to be called.

In another example embodiment, an apparatus comprising at least one processor is provided. The at least one processor may be configured to cause the apparatus of this example embodiment to perform enqueueing, in a message queue selected from one or more message queues implemented in a database, a message including an indication of a function of a third party technology application programming interface corresponding to a call from a user application. The at least one processor may be configured to cause the apparatus of this example embodiment to further perform dequeueing the message from the selected message queue. The at least one processor may be configured to cause the apparatus of this example embodiment to additionally perform causing, based at least in part on the indication included in the dequeued message, the function of the third party technology application programming interface to be called.

In a further example embodiment, a computer program product is provided. The computer program product of this embodiment may include at least one computer-readable storage medium having computer-readable program instructions stored therein. The program instructions of this example embodiment may comprise program instructions configured to enqueue, in a message queue selected from one or more message queues implemented in a database, a message including an indication of a function of a third party technology application programming interface corresponding to a call from a user application. The program instructions of this example embodiment may further comprise program instructions configured to dequeue the message from the selected message queue. The program instructions of this example embodiment may additionally comprise program instructions configured to cause, based at least in part on the indication included in the dequeued message, the function of the third party technology application programming interface to be called.

In yet another example embodiment, an apparatus is provided. The apparatus of this example embodiment may comprise means for enqueueing, in a message queue selected from one or more message queues implemented in a database, a message including an indication of a function of a third party technology application programming interface corresponding to a call from a user application. The apparatus of this example embodiment may further comprise means for dequeueing the message from the selected message queue. The apparatus of this example embodiment may also comprise means for causing, based at least in part on the indication included in the dequeued message, the function of the third party technology application programming interface to be called.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a system for facilitating integration of third party technology with a database according to some example embodiments;

FIG. 2 illustrates a block diagram of a database apparatus according to some example embodiments;

FIG. 3 illustrates an example architecture of a system for facilitating integration of third party technology with a database according to some example embodiments;

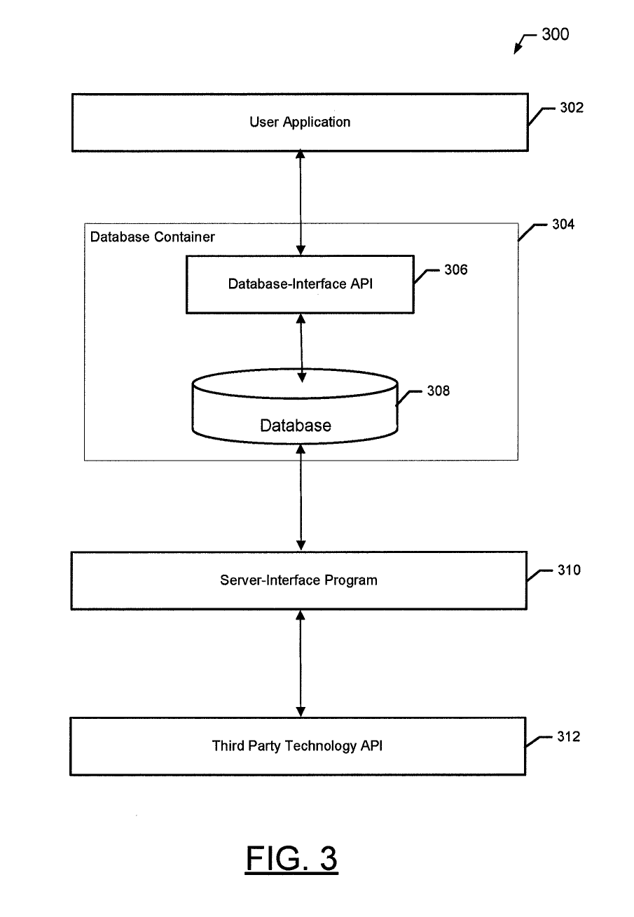

FIG. 4 illustrates a flowchart according to an example method for facilitating integration of third party technology with a database according to some example embodiments; and

FIG. 5 illustrates a flowchart according to another example method for facilitating integration of third party technology with a database according to some example embodiments.

### DETAILED DESCRIPTION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, propagated (e.g., through a message queue in a database), displayed and/or stored in accordance with various example embodiments. Thus, use of any such terms should not be taken to limit the spirit and scope of the disclosure. Further, where a computing device, or application running thereon, is described herein to receive data from another computing device or application, it will be appreciated that the data may be received directly from the another computing device or application, or may be received indirectly via one or more intermediary computing devices, such as, for example, one or more servers, relays, routers, network access points, and/or the like.

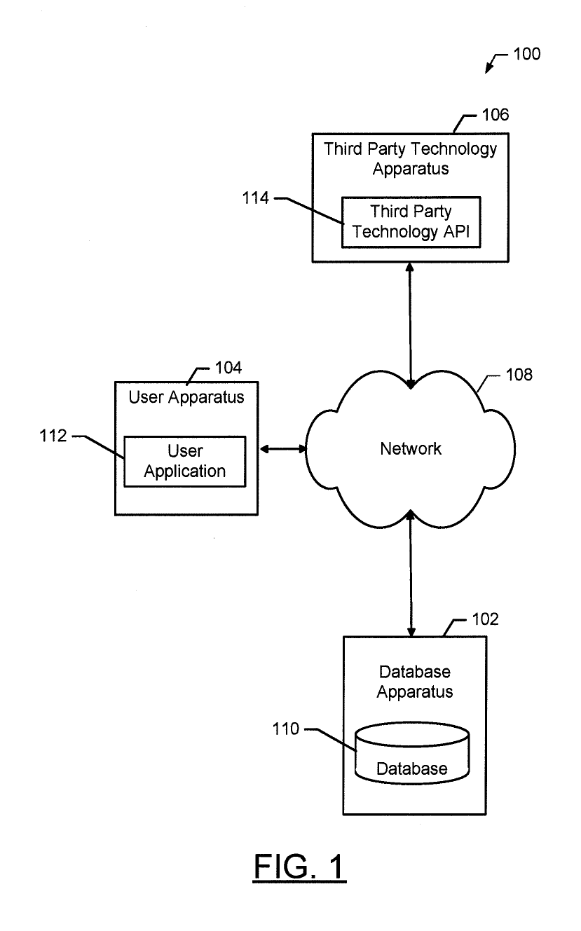

Referring now to FIG. 1, FIG. 1 illustrates a block diagram of a system 100 for facilitating integration of third party technology with a database according to some example embodiments. It will be appreciated that the system 100 as well as the illustrations in other figures are each provided as an example of some embodiments and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for facilitating integration of third party technology with a database, numerous other configurations may also be used to implement embodiments of the present invention.

In some example embodiments, the system 100 may include a database apparatus 102, which may have a database 110 at least partially embodied thereon. The database apparatus 102 may comprise any computing device or plurality of computing devices having the database 110 at least partially embodied thereon, which is configured to facilitate integration of a third party technology API with the database 110 in accordance with one or more example embodiments. By way of non-limiting example, the database apparatus 102 may comprise one or more servers, a server cluster, one or more network nodes, a cloud computing infrastructure, a distributed apparatus, one or more desktop computers, one or more laptop computers, one or more mobile computing devices, one or more mobile phones, one or more tablet computing devices, one or more network nodes, multiple computing devices in communication with each other, any combination thereof, and/or the like.

The database 110 may comprise any database having a message queueing functionality that may be leveraged by one or more example embodiments for purposes of facilitating inter-process communication between a user application (e.g., the user application 112) and a third party technology API (e.g., the third party technology API 114) to enable integration of the third party technology with the database. In some example embodiments, the database 110 comprises an Oracle® database. However, it will be appreciated that embodiments are not limited to usage of an Oracle database. As such, where embodiments are discussed with respect to the use of Oracle databases, it will be appreciated that this discussion is by way of example, and not by way of limitation. In embodiments wherein the database 110 comprises an Oracle database, Oracle Streams™ may be used to implement message queues used in accordance with some example embodiments. However, it will be appreciated that other techniques may be used to implement message queues for propagating messages through the database 110 in other example embodiments. As such, it will be appreciated that where usage of Oracle Streams is discussed with respect to some example embodiments, that discussion is provided by way of example, and not by way of limitation.

The system 100 may additionally comprise a user apparatus 104 and/or a third party technology apparatus 106, which may be configured to communicate with the database apparatus 102 via a network 108. The network 108 may comprise one or more wireless networks (for example, a cellular network, wireless local area network, wireless metropolitan area network, wireless personal area network, such as a Bluetooth network, and/or the like), one or more wireline networks, or some combination thereof, and in some embodiments may comprise at least a portion of the Internet.

The user apparatus 104 may comprise any computing device configured to run, such as on a processor of the user apparatus 104 (not illustrated), a user application 112. By way of non-limiting example, the user apparatus 104 may be embodied as a computer, laptop computer, server, mobile computing device, mobile phone, game device, digital camera/camcorder, audio/video player, digital video recorder, positioning device, personal digital assistant (PDA), any combination thereof, and/or the like.

The third party technology apparatus 106 may comprise any computing device, apparatus, machine, combination of multiple devices, and/or the like providing one or more functionalities. Functionalities provided by the third party technology apparatus 106 may, for example, comprise software functionality, mechanical functionality, electromechanical functionality, and/or the like. The third party technology apparatus 106 may include a third party technology API 114, which may comprise an API configured to control one or more functionalities of the third party technology apparatus 106 based on a call(s) made to the third party technology API 114.

The user application 112 may comprise a consumer of services that may be provided by the third party technology apparatus 106 and, more particularly, services that may be provided through integration of a third party technology with a database in accordance with one or more example embodiments. In this regard, the user application 112 may comprise any application configured to make one or more calls that correspond to one or more functions provided by a third party technology API, such as the third party technology API 114. In some example embodiments, the user application 112 may comprise any application configured to interface to the third party technology API 114 by way of an interface to the database 110 provided by the database apparatus 102 in some example embodiments. In this regard, in accordance with some example embodiments, calls made by the user application 112 may be converted to messages propagated through the database 110 by the database apparatus 102. The propagated messages may be used by the database apparatus 102 to call a function of the third party technology API 114 corresponding to a call by the user application 112.

In some embodiments, the user application 112 may be controlled by a human user. In this regard, the user application 112 may include a user interface allowing a user to select and/or make a call corresponding to a function of the third party technology API 114. However, it will be appreciated that while referred to as a “user” application, the user application 112 is not limited to embodiments wherein calls made by the user application 112 are triggered by human interaction with the user application 112. In this regard, in some example embodiments, the user application 112 may comprise an application that is at least partially automated, controlled by artificial intelligence, and/or the like.

While the user application 112 is illustrated in FIG. 1 as being on a user apparatus 104 that is logically separated from the database 102, in some example embodiments the user application 112 may be implemented on the database apparatus 102. In some example embodiments, the user application 112 may even be stored on or otherwise implemented within the database 110. In embodiments wherein the user application 112 is implemented on the database apparatus 102, the user apparatus 104 may comprise a component of the database apparatus 102, or the user apparatus 104 may even be eliminated. As such, it will be appreciated that the illustration of the user application 112 being implemented on a user apparatus 104 that is logically separated from the database 102 is by way of illustrative example, and not by way of limitation.

Further, while the third party technology apparatus 106 is illustrated in the example of FIG. 1 as being logically separate from the database apparatus 102, in some example embodiments the third party technology apparatus 106 may be co-located with or otherwise implemented on the database apparatus 102. As such, it will be appreciated that the illustration of the third party technology apparatus 106 being logically separated from the database 102 is by way of illustrative example, and not by way of limitation.

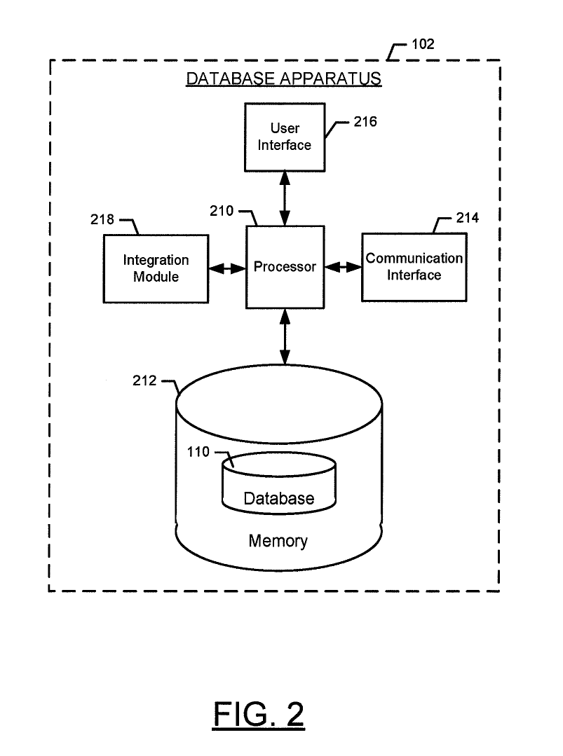

FIG. 2 illustrates a block diagram of a database apparatus 102 according to some example embodiments. In some example embodiments, the database apparatus 102 may include various means for performing the various functions described herein. These means may include, for example, one or more of a processor 210, memory 212, communication interface 214, user interface 216, or integration module 218. The means of the database apparatus 102 as described herein may be embodied as, for example, circuitry, hardware elements (e.g., a suitably programmed processor, combinational logic circuit, and/or the like), a computer program product comprising a computer-readable medium (e.g., memory 212) storing computer-readable program instructions (e.g., software or firmware) that are executable by a suitably configured processing device (e.g., the processor 210), or some combination thereof.

The processor 210 may, for example, be embodied as various means including one or more processors, one or more microprocessors, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 210 may comprise a plurality of processors. The plurality of processors may be embodied on a single computing device or may be distributed across a plurality of computing devices collectively configured to function as the database apparatus 102. The plurality of processors may be in operative communication with each other and may be collectively configured to perform one or more functionalities of the database apparatus 102 as described herein. In some example embodiments, the processor 210 is configured to execute instructions stored in the memory 212 and/or that are otherwise accessible to the processor 210. These instructions, when executed by the processor 210, may cause the database apparatus 102 to perform one or more of the functionalities of the database apparatus 102 as described herein. As such, whether configured by hardware or software methods, or by a combination thereof, the processor 210 may comprise an entity capable of performing operations according to embodiments of the present invention while configured accordingly. Thus, for example, when the processor 210 is embodied as an ASIC, FPGA or the like, the processor 210 may comprise specifically configured hardware for conducting one or more operations described herein. Alternatively, as another example, when the processor 210 is embodied as an executor of instructions, such as may be stored in the memory 212, the instructions may specifically configure the processor 210 to perform one or more algorithms and operations described herein.

The memory 212 may include, for example, volatile and/or non-volatile memory. In this regard, the memory 212 may comprise a non-transitory computer-readable storage medium. Although illustrated in FIG. 2 as a single memory, the memory 212 may comprise a plurality of memories. The plurality of memories may be embodied on a single computing device or distributed across a plurality of computing devices. The memory 212 may comprise volatile memory, non-volatile memory, or some combination thereof. In this regard, the memory 212 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 212 may be configured to store information, data, applications, instructions, or the like for enabling the database apparatus 102 to carry out various functions in accordance with example embodiments of the present invention. For example, in at least some embodiments, the memory 212 is configured to buffer input data for processing by the processor 210. Additionally or alternatively, in at least some embodiments, the memory 212 is configured to store program instructions for execution by the processor 210. The memory 212 may store information in the form of static and/or dynamic information. In some example embodiments, at least a portion of the database 110 is stored on the memory 212. This stored information may be stored and/or used by the integration module 218 during the course of performing its functionalities.

The communication interface 214 may be embodied as any device or means embodied in circuitry, hardware, a computer program product comprising computer readable program instructions stored on a computer readable medium (e.g., the memory 212) and executed by a processing device (e.g., the processor 210), or a combination thereof that is configured to receive and/or transmit data from/to another device, such as, a user apparatus 104, third party technology apparatus 106, and/or the like. In some example embodiments, the communication interface 214 is at least partially embodied as or otherwise controlled by the processor 210. In this regard, the communication interface 214 may be in communication with the processor 210, such as via a bus. The communication interface 214 may include, for example, an antenna, a transmitter, a receiver, a transceiver, a network interface card, and/or supporting hardware or software for enabling communications with another computing device. The communication interface 214 may be configured to receive and/or transmit data using any protocol that may be used for communications between computing devices. As an example, the communication interface 214 may be configured to receive and/or transmit data using any protocol that may be used for communication over the network 108. The communication interface 214 may additionally be in communication with the memory 212, user interface 216, and/or integration module 218, such as via a bus.

The user interface 216 may be in communication with the processor 210 to receive an indication of a user input and/or to provide an audible, visual, mechanical, or other output to a user. As such, the user interface 216 may include, for example, a keyboard, a mouse, a joystick, a display, a touch screen display, a microphone, a speaker, and/or other input/output mechanisms. The user interface 216 may be in communication with the memory 212, communication interface 214, and/or integration module 218, such as via a bus. In embodiments wherein the database apparatus 102 is embodied as one or more servers, aspects of the user interface 216 may be reduced, or the user interface 216 may even be removed entirely. In embodiments wherein the user application 112 is implemented on the database 102, the user interface 216 may provide a means for entering commands to and/or otherwise interacting with the user application 112, such as for purposes of controlling a functionality of the third party technology apparatus 106.

The integration module 218 may be embodied as various means, such as circuitry, hardware, a computer program product comprising a computer-readable medium (e.g., memory 212) storing computer-readable program instructions (e.g., software or firmware) that are executable by a suitably configured processing device (e.g., the processor 210), or some combination thereof and, in some example embodiments, is embodied as or otherwise controlled by the processor 210. The integration module 218 may accordingly provide means for performing the various operations described to be performed by the integration module 218 in accordance with various example embodiments. In embodiments wherein the integration module 218 is embodied separately from the processor 210, the integration module 218 may be in communication with the processor 210. The integration module 218 may further be in communication with one or more of the memory 212, communication interface 214, or user interface 216, such as via a bus.

In some example embodiments, the integration module 218 is configured to enqueue a message including an indication of a function of the third party technology API 114 in a message queue selected from one or more message queues implemented in the database 110. As such, the integration module 218 may provide means for enqueueing a message. The message may further comprise additional information, such as a value(s) corresponding to a parameter(s) for use in calling the function of the third party technology API 114.

In some example embodiments, the enqueued message may be at least partially formatted by the user application 112. In such embodiments, the user application 112 may be aware of at least some aspects of an interface to the database 110, such that the user application 112 may be configured to provide the message to a message queue functionality of the database 110 for enqueueing. In some such embodiments, the user application 112 may be implemented on the database 110.

Alternatively, in some example embodiments, the integration module 218 is configured to provide an interface between a user application, such as the user application 112, and the database 110. In this regard, the integration module 218 may be configured to receive a call by the user application. The integration module 218 may determine information to include in the message to be enqueued based at least in part on the type of call received from the user application and/or information included in the call, such as one or more parameters. In this regard, a call received from the user application may correspond to a value(s) that may be included in the message, which may be translated to call a function of the third party technology API 114 after the message has been propagated through the database and dequeued, as will be described further herein below. The integration module 218 may accordingly format a message including information determined to correspond to the call from the user application and enqueue the message.

In some example embodiments, the interface between the user application 112 and database 110 may comprise a database-interface API, which may serve as a logical layer between the user application 112 and the database 110. Functionality of the database-interface API may be at least partially controlled by the integration module 218. Accordingly, the user application 112 may be implemented in a manner that is agnostic to the underlying database 110, as the application 112 may be unaware of the actual interface to the database 110. The database-interface API may be implemented at a variety of locations in the system 100. For example, in some example embodiments, the database-interface API may be at least partially implemented on the user apparatus 104.

As another example, in some example embodiments, the database-interface API may be at least partially implemented on the database apparatus 102. For example, the database-interface API may be at least partially integrated into or otherwise stored on the database 110. In this regard, the database-interface API may comprise a package of one or more functions and/or one or more procedures that may be called by the user application 112. A respective function and/or procedure of the database-interface API may correspond to a respective function of the third party technology API 114, and may provide rules for formatting a message to be enqueued to facilitate inter-process communication between the user application 112 and third party technology API. Accordingly, in some example embodiments, the user application 112 may be enabled to control a functionality of the third party technology apparatus 106 by calling a procedure or function of the database-interface API.

It is important to note that the term “function” is generally construed herein to be inclusive of function, procedure, process, method, program, and/or the like, regardless of whether that “function” returns a value when called. In this regard, the terms “procedure,” “function,” and the like may generally be used interchangeably. The terms “procedure” and “function” may only have a difference in semantic meaning when used in the context of being implemented within a database. In this regard, when used in such a context, such as in embodiments wherein a database-interface API comprising a package of one or more procedures and/or one or more functions is stored on or otherwise integrated into the database 110, a “function” may comprise a program or code segment including a return statement that returns a value in response to the function being called, while a “procedure” may comprise a program or code segment that does not necessarily return a value.

The integration module 218 is further configured in some example embodiments to dequeue an enqueued message and, as such, may provide means for dequeueing a message. The integration module 218 may also be configured to cause a function of the third party technology API 114 to be called based at least in part on information included in the dequeued message. In this regard, the message may include information indicating a function of the third party technology API 114. The integration module 218 may be configured to translate this indication into the appropriate call to the third party technology API 114. The call to the third party technology API 114 may control a functionality of the third party technology apparatus 106, such as in accordance with the call from the user application 112.

In some example embodiments, the integration module 218 may format a call to the third party technology API 114 on the basis of information included in the message. For example, the message may include information corresponding to the value(s) of a parameter(s) in addition to the indication of the function of the third party technology API 114. The integration module 218 may accordingly format a call including the corresponding parameter(s) and use the formatted call to call the indicated function of the third party technology API 114.

Accordingly, the integration module 218 may be configured to provide an interface between the database 110 and the third party technology API 114. This interface may, for example, comprise a server-interface program which may be at least partially controlled by the integration module 218.

Attendant to providing an interface between the database 110 and the third party technology API 114, the integration module 218 may be configured in some example embodiments to maintain state information. This state information may, for example, include state information for at least one interaction with the third party technology API 114 that may be generated in response to one or more calls from the user application 112. The integration module 218 may use this state information to manage interactions between the user application 112 and third party technology API 114 via the database 110 (e.g., via one or more message queues that may be used to facilitate inter-process communication between the user application 112 and third party technology API 114 via the database 110). The state information may accordingly provide a context for managing these interactions.

The integration module 218 may be additionally configured to facilitate inter-process communication from the third party technology API 114 to the user application 112. For example, the third party technology API 114 may return information in response to a function of the third party technology API 114 being called. This information may, for example, comprise a status/confirmation of the call, status information regarding a state of a functionality of the third party technology apparatus 106, and/or the like. The integration module 218 may receive this returned information, and may format a message including an indication of the information received from the third party technology API 114. The included indication may comprise the actual information received from the third party technology API 114 or a corresponding translated value of the information, such as may be understood by the user application 112 and/or by a database-interface API that may interface between the database 110 and the user application 112. The integration module 218 may enqueue this message in a queue selected from one or more message queues that may be implemented in the database 110. The integration module 218 may subsequently dequeue the message and inform the user application 112 of the information received from the third party technology API 114.

In some example embodiments, the user application 112 may be configured to wait for a message containing status information to be returned in response to a call made by the user application 112. Accordingly, the user application 112 may wait to receive a message dequeued by the integration module 218 and forwarded to the user application 112. Alternatively, the user application 112 may be configured to directly interact with the message queue(s) and dequeue a message containing returned status information. In some embodiments wherein the user application 112 waits for a response message, the user application 112 may wait for a defined time-out period. If the time-out period expires without receiving a return message, the user application 112 may consider an exception to have occurred and, depending on the embodiment, may take action, such as notifying a user, making the previous call again, and/or the like in response to the exception.

Having generally described the implementation of several example embodiments, some example embodiments will now be more particularly described with respect to the example architecture 300 of a system for facilitating integration of third party technology with a database according to some example embodiments. It will be appreciated, however, that the selection and arrangement of elements of the architecture 300 are provided by way of example, and not by way of limitation. In this regard design variations, such as those previously described, as well as other design variations are contemplated within the scope of the disclosure.

The architecture 300 may include a user application 302. The user application 302 may, for example, comprise an embodiment of the user application 110 and, as such, may be implemented on a user apparatus 104, database apparatus 102, and/or the like. The user application 302 may comprise any application configured to interface to a third party technology API (e.g., the third party technology API 312 via a database interface, such as may be provided by the database-interface API 306. This user application 302 may accordingly be configured to make calls to procedures and/or functions that may be stored within the database. The procedures and/or functions may be contained within a package stored in the database, or alternatively, may be stored independently within the database (e.g., not contained within a stored package).

The architecture 300 may further comprise a database container 304. In essence, the database container 304 may comprise a database, including any applications, packages, functions, procedures, and/or the like stored therein. As such, the database container 304 may comprise an embodiment of the database 110. As such, the database container 304 may, for example, be implemented on a database apparatus 102. In some example embodiments, including some which will be described with respect to the architecture 300, the database container 304 may comprise an Oracle database.

The database container 304 may include a database-interface API 306, which may be stored in the database container 304. Operation of the database-interface API 306 may, for example, be controlled by the integration module 218. The database-interface API 306 may comprise a collection of one or more functions and/or one or more procedures, which may be called by the user application 302. The functions and/or procedures of the database-interface API 306 may be contained within a package stored in the database container 304, or may be stored independently. In some example embodiments, the database-interface API 306 may be written or otherwise implemented in Procedural Language/Structured Query Language (PL/SQL). However, it will be appreciated that embodiments described wherein the database-interface API 306 is implemented using PL/SQL are provided by way of example, and not by way of limitation.

The database-interface API 306 may be configured to provide an interface between the user application 302 and the general database interface of the database container 304, which is illustrated in the architecture 300 as the database 308. The database 308 may include a message queueing functionality, which may implement one or more message queues. In some example embodiments wherein the database container 304 comprises an Oracle database, the message queues may comprise data queue structures maintained by Oracle Streams. This arrangement may advantageously enable substantially real time exchange of messages between independent processes (e.g., sessions) executing within the database. Accordingly, the data queues may be leveraged to facilitate substantially real time inter-process communication between the user application 302 and the third party technology API 312, thereby enabling integration of a third party technology into the database. The number of message queues used to facilitate the inter-process communication may vary depending on design choice and the particular application to which an embodiment is being applied.

The database-interface API 306 may accordingly be configured to transform a function/procedure call, along with any parameters (e.g., required and/or optional parameters), and place the information in a message. The database-interface API 306 may enqueue the message in a message queue maintained in the database 308.

In some example embodiments, the database-interface API 306 may be configured to process events, conditions, and/or calls generated by the user application 302 without enqueueing a message to propagate the message through the database 308 toward the third party technology API 312. In this regard, some events, conditions, and/or calls generated by the user application 302 may not be intended for handling by the third party technology API 312 and/or may be handled directly by the database-interface API 306.

The architecture 300 may further include a server-interface program 310. The server-interface program 310 may, for example, be at least partially implemented on the database apparatus 102, and may operate under the control of the integration module 218. The server-interface program 310 may comprise any application program which is capable of interacting with both the database 308 and the third party technology API 312. The server-interface program 310 may accordingly be configured to make calls to the database 308 dequeue the encoded messages placed in a message queue(s) by the database-interface API 306. The server-interface program 310 may make calls to the third party technology API 312, as directed by the encoded messages dequeued from the message queue(s).

In some example embodiments, the database-interface API 306 may be configured to receive and process dequeued messages without interacting with the third party technology API 312. In this regard, some events, conditions, and/or calls that may be propagated through the database 308 in a message may be handled directly by the database-interface API 306.

The database-interface API 306 and/or server-interface program 310 may be further configured to maintain ‘state’ information. The state information may, for example, include indications that determine a current point of an application within a discrete multi-step process. For example, state information that may be maintained by the server-interface program 310 may include state information that may support the orderly management of interactions generated by the user application 302 and/or the database-interface API 306. The state information may provide a ‘context’ within which the server-interface program 310 may manage interaction between the user application 302, the database-interface API 306, and the third party technology API 312. Similarly, state information maintained by the database-interface API 306 may provide a context within which the database-interface API 306 may manage interaction between the user application 302, the server-interface program 310, and the third party technology API 312.

The server-interface program 310 may additionally be configured to format a message containing information returned by the third party technology API 312. The server-interface program 310 may enqueue this message in a message queue. The message may be dequeued by the database-interface API 306, which may transform (if needed) the information within the message into a form appropriate for use and consumption by the user application 302. The database-interface 306 may forward (e.g., return) this information to the user application 302. Additionally or alternatively, the database-interface 306 may dequeue and process a message without forwarding information from the message to the user application 302.

The server-interface program 310 may be configured to directly process some events, conditions, and/or messages generated by the third party technology API 312 and/or by the underlying third party technology without generating and enqueueing a message to be propagated toward the database-interface API 306 and/or toward the user application 302.

The third party technology API 312 may, for example, comprise an embodiment of the third party technology API 114. As such, the third party technology API 312 may, for example, be implemented on a third party technology apparatus 106, on the database apparatus 102, and/or the like. The third party technology API 312 is configured in some example embodiments to provide capabilities and features, such as may be specific to the third party technology. These capabilities and features can be ‘accessed’ (e.g., called) by the server-interface program 310. The third party technology may, for example, include specific hardware and/or discrete ‘logical’ capabilities that can be accessed by the third party technology API 312.

Having now generally described various example embodiments of the architecture 300, a functional description of the architecture 300 will be provided in the context of integration between a (e.g., the database 308) and a third party technology API (e.g., the third party technology API 312) configured to run an ‘industrial’ washing machine. In this regard, the industrial washing machine may, for example, comprise an embodiment of a third party technology apparatus 106, and may provide third party technology referred to as ‘Dyno Wash 2.0.’

In the industrial washing machine example, the third party technology API (e.g., the third party technology API 312) may provide a function which can be called. The function of this example runs a wash cycle of the industrial washing machine. The wash cycle of this example can be run in delicate, normal or heavy-duty mode. The wash cycle mode may be indicated by a parameter included in the call to the wash-cycle function.

The user application (e.g., the user application 302) of the industrial washing machine example may be stored within the database (e.g., within the database container 304). Accordingly, it will be appreciated that design variations, such as integration of the user application 302 within the database container 304 are contemplated within the scope of the architecture 300. As such, the user application of the industrial washing machine example may, for example, exist as a package stored in the database, which may be written in PL/SQL. The user application of this example may, for example, be triggered/called by a database command-line utility program, such as SQL*Plus. The user application of this example may be called in three modes—delicate-cycle, normal-cycle and heavy-duty cycle. The called mode may be indicated by separate procedures that may be contained within a stored package for each of the delicate-cycle, normal-cycle and heavy-duty cycle. Example code for a portion of the user application of the industrial washing machine example is provided in Appendix A. It will be appreciated, however, that this code is provided by way of example, and not by way of limitation. In this regard, other methods of coding the user application are contemplated within the scope of the disclosure.

Depending upon which mode of the user application is called, the user application may call a ‘dynoWash’ package that may be provided by the database-interface API (e.g., the database-interface API 306) of the industrial washing machine example to cause the industrial washing machine to run the appropriate wash cycle. The dyno Wash package may comprise a function called ‘run_cycle.’ The dynoWash package may rely on features and capabilities of a messaging facility that may be provided by the database interface (e.g., the database 308). In some embodiments, the messaging facility may comprise a message queue(s) maintained by Oracle Streams. Messages sent (e.g., enqueued in a message queue) by the dynoWash package may be sent using a substantially ‘immediate’ and ‘buffered’ delivery scheme.

The dynoWash database-interface API package may be configured to send (e.g., enqueue) encoded messages to the server-interface program 310 using a data-type designed to the requirements of the third party technology integration. It will be appreciated that there are no restrictions or requirements on the data sent between communicating database processes contemplated within the scope of the disclosure. In this regard, the data sent may vary depending on the application, type of third party technology integrated into the database, individual design choice, and/or on other factors. Similarly, the content and layout of the information exchanged by way of a message queue(s) may vary depending on the application, type of third party technology integrated into the database, on design considerations taken into account when implementing an integration of a database to third party technology, and/or the like.

An example definition of the data type, ‘dynoWash_data’, which may be used by the industrial washing machine example is as follows:

| | |
|---|---|
| create or replace | |
| type dynoWash_data as object ( | |
| function_requested | pls_integer; |
| message_payload | varchar2(512)); |

The number of message queues may likewise vary depending on design choices, requirements of a particular third party technology integration, and/or other factors. In some embodiments, intelligent dequeue operations may be used, where specific messages may be dequeued based upon data contained in the message and a condition specified by the dequeueing application (e.g., the server-interface program 310 and/or the database-interface API 306). Intelligent dequeueing operations may, for example be facilitated through use of Oracle Streams. Intelligent dequeueing may, for example, allow for the use of a single message queue by more than one interacting agent.

In some example embodiments of the industrial washing machine example, two queues may be used. These queues may be named ‘dynoWash_server’ and ‘dynoWash_client,’ respectively. The dynoWash_server queue may be used to communicate information to the server-interface program 310, while the dynoWash_client queue may be used to return information from the third party technology API 312 to the user application 302 via the server-interface program 310 and the database-interface API 306. The following example code segments define these message queues:

```
  dbms_aqadm.create_queue_table(
  queue_table => ‘dynoWash_server’,
  queue_payload_type => ‘dynoWash_data’);
  dbms_aqadm.create_queue(
  queue_name => ‘dynoWash_server’,
  queue_table => ‘dynoWash_server’);
  dbms_aqadm.create_queue_table(
      queue_table => ‘dynoWash_client’,
      queue_payload_type => ‘dynoWash_data’);
dbms_aqadm.create_queue(
  queue_name => ‘dynoWash_client’,
  queue_table => ‘dynoWash_client’);
```

The database-interface API 306 may examine parameter information included in the procedure/function call to the dynoWash package, and may make any transformation of values needed for formatting of the message to enqueue and propagate to the server-interface program. The database-interface API 306 may encode the information in the dynoWash_data data-type. The database-interface API 306 may enqueue the message into the dynoWash_server. Example code that may be used to implement some of the interaction between the database-interface API 306 and the database queues is provided in Appendix B. It will be appreciated, however, that this code is provided by way of example, and not by way of limitation.

The server-interface program 310 may wait for the arrival of a message in a message queue. In response to receiving a message, the server-interface program 310 may make the appropriate call to the third party technology API 312. The server-interface program 310 may further store any relevant (e.g., required) state/context information.

After making the appropriate call to the third party technology API 312, the server-interface program 310 may, depending upon the design requirements of the third party technology integration, return a status value or other information to the user application 302 via the message queues and the database-interface API 306.

The server-interface program 310 may be written in any programming language that is capable of interfacing to both the database 308 (e.g., to an Oracle API of the database 308) and the third party technology API 312. As an example, the server-interface program 310 may be written in C/C++. An example ‘C’ based server-interface program that may be used to implement the server-interface program of the industrial washing machine example is described in Appendix C. It will be appreciated, however, that this code is provided by way of example, and not by way of limitation.

After enqueueing a message the database-interface API 306 may or may not, as determined by the design considerations of the 3^{rd} party technology integration, wait for a period of time, perhaps indefinitely, for a message to be enqueued into the dynoWash_client message queue. The enqueued message, if, for example, specified by the design of the third party technology integration, may be created by the server-interface program 310.

In response to receiving a message enqueued in the dynoWash_client message queue, the database-interface API 306 may return information to the user application 302 in accordance with any design requirements of the third party technology integration. Example code which may be used to implement this interaction between the database-interface API 306 and message queue(s) is provided in Appendix D. It will be appreciated, however, that this code is provided by way of example, and not by way of limitation.

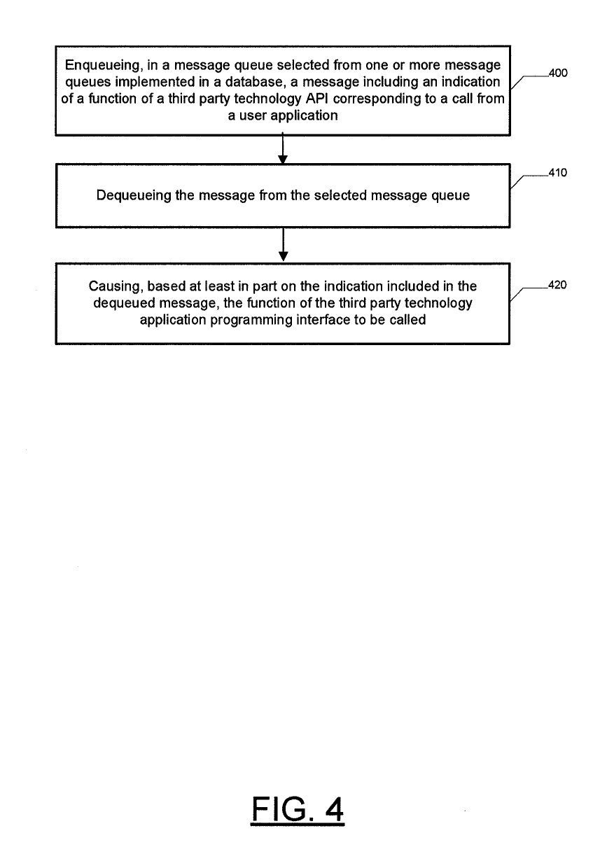

FIG. 4 illustrates a flowchart according to an example method for facilitating integration of third party technology with a database according to some example embodiments. In this regard, FIG. 4 illustrates operations that may, for example, be performed by a database apparatus 102. The operations illustrated in and described with respect to FIG. 4 may, for example, be performed by, with the assistance of, and/or under the control of one or more of the processor 210, memory 212, communication interface 214, user interface 216, or integration module 218. Operation 400 may comprise enqueueing, in a message queue selected from one or more message queues implemented in a database, a message including an indication of a function of a third party technology API corresponding to a call from a user application. The processor 210, memory 212, communication interface 214, and/or integration module 218 may, for example, provide means for performing operation 400. Operation 410 may comprise dequeueing the message from the selected message queue. The processor 210, memory 212, communication interface 214, and/or integration module 218 may, for example, provide means for performing operation 410. Operation 420 may comprise causing, based at least in part on the indication included in the dequeued message, the function of the third party technology application programming interface to be called. The processor 210, memory 212, communication interface 214, and/or integration module 218 may, for example, provide means for performing operation 420.

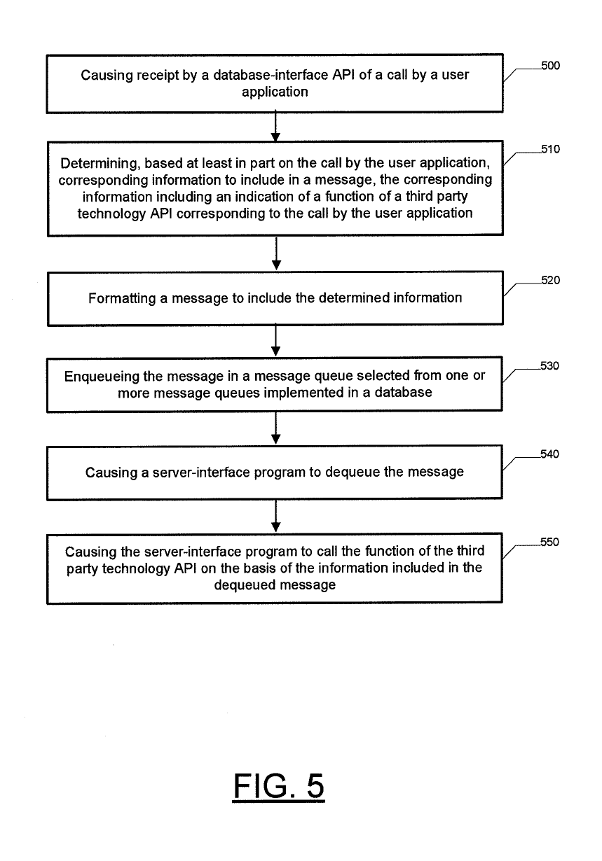

FIG. 5 illustrates a flowchart according to another example method for facilitating integration of third party technology with a database according to some example embodiments. In this regard, FIG. 5 illustrates operations that may, for example, be performed by a database apparatus 102. The operations illustrated in and described with respect to FIG. 5 may, for example, be performed by, with the assistance of, and/or under the control of one or more of the processor 210, memory 212, communication interface 214, user interface 216, or integration module 218. Operation 500 may comprise causing receipt by a database-interface API of a call by a user application. The processor 210, memory 212, communication interface 214, and/or integration module 218 may, for example, provide means for performing operation 500. Operation 510 may comprise determining, based at least in part on the call by the user application, corresponding information to include in a message. The determined corresponding information may include an indication of a function of a third party technology API corresponding to the call by the user application. The processor 210, memory 212, communication interface 214, and/or integration module 218 may, for example, provide means for performing operation 510. Operation 520 may comprise formatting a message to include the determined information. The processor 210, memory 212, and/or integration module 218 may, for example, provide means for performing operation 520. Operation 530 may comprise enqueueing the message in a message queue selected from one or more message queues implemented in a database. The processor 210, memory 212, communication interface 214, and/or integration module 218 may, for example, provide means for performing operation 530. Operation 540 may comprise causing a server-interface program to dequeue the message. The processor 210, memory 212, communication interface 214, and/or integration module 218 may, for example, provide means for performing operation 540. Operation 550 may comprise causing the server-interface program to call the function of the third party technology API on the basis of the information included in the dequeued message. The processor 210, memory 212, communication interface 214, and/or integration module 218 may, for example, provide means for performing operation 550.

FIGS. 4-5 each illustrate a flowchart of a system, method, and computer program product according to example embodiments of the invention. It will be understood that each block or step of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices (e.g., the memory 212) of a server, desktop computer, laptop computer, mobile computer, or other computing device (e.g., a database apparatus 102, a user apparatus 104, a third party technology apparatus 106, some combination thereof, and/or the like) and executed by a processor (e.g., the processor 210) in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function(s) specified in the flowchart block(s). The computer program instructions of one or more computer program products may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s).

Accordingly, blocks of the flowcharts support combinations of means for performing the specified functions and combinations of operations for performing the specified functions. It will also be understood that one or more blocks of the flowcharts, and combinations of blocks in the flowcharts, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

APPENDIX A

```
create package body washer_package as
  procedure delicate_cycle
  is
  declare
    return_status  pls_integer;
  begin
    return_status := dynoWash.run_cycle(‘delicate’);
  end delicate_cycle;
  procedure normal_cycle
  is
  declare
    return_status  pls_integer;
  begin
    return_status := dynoWash.run_cycle(‘normal’);
  end normal_cycle;
  procedure heavy_duty_cycle
  is
  declare
    return_status  pls_integer;
  begin
    return_status := dynoWash.run_cycle(‘heavy-duty’);
  end heavy_duty_cycle;
end washer_package;
```

APPENDIX B
.. create package body dynoWash as ..
function run_cycle

| | |
|---|---|
| (cycle_mode | varchar2) |
| return pls_integer | |
| is | |

| | |
|---|---|
| message | dynoWash_data; |
| dequeue_options | DBMS_AQ.dequeue_options_t; |
| enqueue_options | DBMS_AQ.enqueue_options_t; |
| message_properties | DBMS_AQ.message_properties_t; |
| message_handle | raw(16); |

```
  begin
    if cycle_mode = ‘delicate’ then
      message.message_payload := ‘1’;
      end if;
    if cycle_mode = ‘normal’ then
      message.message_payload := ‘2’;
      end if;
  if cycle_mode = ‘heavy-duty’ then
      message.message_payload := ‘3’;
      end if;
    message.function_requested := 100;
            message_properties.expiration :=
            MESSAGE_EXPIRATION;
              enqueue_options.visibility := DBMS_AQ.IMMEDIATE;
    enqueue_options.delivery_mode := DBMS_AQ.BUFFERED;
    dbms_aq.enqueue(
      queue_name => ‘dynoWash_server’,
      enqueue_options => enqueue_options,
      message_properties => message_properties,
      payload => message,
      msgid => message_handle);
..
  ..
    end run_cycle;
  end dynoWash;
```

APPENDIX C
int process3rdPartyInterfaceRequest(void) {
int rc = 0, functionRequested = 0;
char messagePayload[512];
char *getServerMessageText = “
declare

| | |
|---|---|
| dequeue_options | DBMS_AQ.dequeue_options_t; |
| message_properties | DBMS_AQ.message_properties_t; |
| message_handle | raw(16); |
| message | dynoWash_data; |
| begin | |

```
  dequeue_options.wait := DBMS_AQ.FOREVER;
  dequeue_options.navigation :=
  DBMS_AQ.FIRST_MESSAGE;
  dequeue_options.visibility := DBMS_AQ.IMMEDIATE;
  dequeue_options.delivery_mode :=
  DBMS_AQ.BUFFERED;
  dbms_aq.dequeue(
    queue_name => ‘dynoWash_server,
    dequeue_options => dequeue_options,
    message_properties => message_properties,
    payload => message,
    msgid => message_handle);
  :function_requested := message.function_requested;
  :message_payload := message.message_payload;
end;”;
char *sendClientMessageText = “
declare
  enqueue_options DBMS_AQ.enqueue_options_t;
```

| | |
|---|---|
| message_properties | DBMS_AQ.message_properties_t; |
| message_handle | raw(16); |
| message | dynoWash_data; |
| begin | |

```
  mesage.function_requested = 100;
  message.message_payload := :rc;
  message_properties.expiration :=
  MESSAGE_EXPIRATION; enqueue_options.visibility :=
  DBMS_AQ.IMMEDIATE;
  enqueue_options.delivery_mode := DBMS_AQ.BUFFERED;
  dbms_aq.enqueue(
    queue_name => ‘dynoWork_client’,
    enqueue_options => enqueue_options,
    message_properties => message_properties,
    payload => message,
    msgid => message_handle);
end;”;
  ..
  ..
  rc = OCIHandleAlloc(pConn.oraEnv, (void *)&serverMessageHandle,
    OCI_HTYPE_STMT, 0, (dvoid **)0);
  rc  =  OCIStmtPrepare(serverMessageHandle,  pConn.oraError,
  (const OraText *) getServerMessageText,  (ub4)
  strlen(getServerMessageText), OCI_NTV_SYNTAX,
  OCI_DEFAULT);
  rc = OCIBindByName(serverMessageHandle, &messageDataBV,
    pConn.oraError, (const OraText *)“:function_requested”, −1,
    &functionRequested, (ub4) sizeof(functionRequested),
    SQLT_INT, (dvoid *) 0, (ub2 *)0, (ub2 *)0, (ub4) 0, (ub4 *) 0,
    (sb4) OCI_DEFAULT);
rc = OCIBindByName(serverMessageHandle, messagePayload,
    pConn.oraError, (const OraText *)“:message_payload”,
    −1,messagePayload, (ub4) sizeof(messagePayload)+1, SQLT_STR,
    (dvoid *) 0, (ub2 *)0, (ub2 *)0, (ub4) 0, (ub4 *) 0, (sb4)
    OCI_DEFAULT);
functionRequested = 0;
memset(messagePayload, ‘\0’, sizeof(messagePayload));
rc = OCIStmtExecute(pConn.oraSvcCtx, &serverMessageHandle,
    pConn.oraError, 1, 0, NULL, NULL, OCI_DEFAULT);
..
..
  if (100 == functionRequested)
  {
    perform 3rd party API function call runCycle using parameters
    as specified in messagePayload....
  }
// Return status of 3rd party API function call...
  rc = OCIHandleAlloc(dConn.oraEnv, (void *)&clientMessageHandle,
  OCI_HTYPE_STMT, 0, (dvoid **)0);
  rc = OCIStmtPrepare(clientMessageHandle, dConn.oraError,
  (const OraText *)
  sendClientMessageText, (ub4) strlen(sendClientMessageText),
  OCI_NTV_SYNTAX, OCI_DEFAULT);
  rc = OCIBindByName(clientMessageHandle, &rcBV, dConn.oraError,
    (const OraText *)“:rc”, (ub4) −1, &rc, (ub4) sizeof(rc), SQLT_INT,
    (dvoid *) 0, (ub2 *)0, (ub2 *)0, (ub4) 0, (ub4 *) 0, (ub4)
    OCI_DEFAULT);
  rc = OCIStmtExecute(dConn.oraSvcCtx, clientPipeHandle,
  dConn.oraError, 1, 0,
    NULL, NULL, OCI_DEFAULT);
}
```

```
APPENDIX D
  .. create package body dynoWash as ..
    function run_cycle
```

| | |
|---|---|
| (cycle_mode | varchar2) |
| return pls_integer | |
| is | |

| | |
|---|---|
| message | dynoWash_data; |
| dequeue_options | DBMS_AQ.dequeue_options_t; |
| enqueue_options | DBMS_AQ.enqueue_options_t; |
| message_properties | DBMS_AQ.message_properties_t; |
| message_handle | raw(16); |

```
    begin
  ..
  ..
      dequeue_options.wait := wait_time;
      dequeue_options.navigation := DBMS_AQ.FIRST_MESSAGE;
      dequeue_options.visibility := DBMS_AQ.IMMEDIATE;
      dequeue_options.delivery_mode := DBMS_AQ.BUFFERED;
      dbms_aq.dequeue(
        queue_name => ‘dynoWash_client’,
        dequeue_options => dequeue_options,
        message_properties => message_properties,
        payload => message,
        msgid => message_handle);
    return message.message_payload;
    end run_cycle;
end dynoWash;
```

What is claimed is:

1. A method comprising:
enqueueing, in a message queue selected from one or more message queues implemented in a database, a message including an indication of a function of a third party technology application programming interface corresponding to a call from a user application;
dequeueing, by a processor, the message from the selected message queue; and
causing, based at least in part on the indication included in the dequeued message, the function of the third party technology application programming interface to be called.

2. The method of claim 1, wherein the call from the user application comprises a call of a procedure or function provided by a database-interface application programming interface configured to interface with both the user application and the database, the method further comprising:
causing receipt by the database-interface application programming interface of the call of the procedure or function by the user application;
determining, based at least in part on the procedure or function called by the user application, corresponding information to include in the message, the determined corresponding information to include in the message comprising the indication of the function of the third party technology application programming interface; and
prior to enqueueing the message, formatting the message to include the determined corresponding information.

3. The method of claim 2, wherein the database-interface application programming interface is stored in the database.

4. The method of claim 3, wherein the database-interface application programming interface is at least partially implemented using Programming Language/Structured Query Language (PL/SQL).

5. The method of claim 1, wherein:
dequeueing the message from the selected message queue comprises causing, by the processor, a server-interface program configured to interface with both the database and the third party technology application programming interface to dequeue the message; and
causing the function of the third party technology application programming interface to be called comprises causing the server-interface program to call the function of the third party technology application programming interface.

6. The method of claim 1, wherein the call of the procedure or function by the user application includes an indication of a parameter for the function of the third party technology application programming interface, the method further comprising:
prior to enqueueing the message, formatting the message to include a value corresponding to the parameter; and
prior to causing the function of the third party technology application programming interface to be called, formatting, based at least in part on the value included in the message, a call to the third party technology application programming interface including the parameter,
wherein causing the function of the third party technology application programming interface to be called comprises using the formatted call to call the function of the third party technology application programming interface.

7. The method of claim 1, further comprising:
maintaining state information for at least one interaction with the third party technology application programming interface generated in response to one or more calls from the user application; and
managing interactions between the user application and the third party technology application programming interface via the one or more message queues based at least in part on the state information.

8. The method of claim 1, further comprising:
responsive to the function of the receiving information from the third party technology being called, receiving information from the third party technology application programming interface;
enqueueing a second message in a message queue selected from the one or more message queues, the second message including an indication of the information received from the third party technology application programming interface;
dequeueing the second message; and
informing the user application of the information received from the third party technology application programming interface.

9. The method of claim 1, wherein the database comprises an Oracle database, and wherein Oracle Streams is used to implement the one or more message queues.

10. An apparatus comprising at least one processor, the at least one processor configured to cause the apparatus to at least perform:
enqueueing, in a message queue selected from one or more message queues implemented in a database, a message including an indication of a function of a third party technology application programming interface corresponding to a call from a user application;
dequeueing the message from the selected message queue; and
causing, based at least in part on the indication included in the dequeued message, the function of the third party technology application programming interface to be called.

11. The apparatus of claim 10, wherein the call from the user application comprises a call of a procedure or function provided by a database-interface application programming interface configured to interface with both the user application and the database, and wherein the at least one processor is configured to cause the apparatus to further perform:
causing receipt by the database-interface application programming interface of the call of the procedure or function by the user application;
determining, based at least in part on the procedure or function called by the user application, corresponding information to include in the message, the determined corresponding information to include in the message comprising the indication of the function of the third party technology application programming interface; and
prior to enqueueing the message, formatting the message to include the determined corresponding information.

12. The apparatus of claim 11, wherein the database-interface application programming interface is stored in the database.

13. The apparatus of claim 12, wherein the database-interface application programming interface is at least partially implemented using Programming Language/Structured Query Language (PL/SQL).

14. The apparatus of claim 10, wherein:
dequeueing the message from the selected message queue comprises causing a server-interface program configured to interface with both the database and the third party technology application programming interface to dequeue the message; and
causing the function of the third party technology application programming interface to be called comprises causing the server-interface program to call the function of the third party technology application programming interface.

15. The apparatus of claim 10, wherein the call of the procedure or function by the user application includes an indication of a parameter for the function of the third party technology application programming interface, and wherein the at least one processor is configured to cause the apparatus to further perform:
prior to enqueueing the message, formatting the message to include a value corresponding to the parameter; and
prior to causing the function of the third party technology application programming interface to be called, formatting, based at least in part on the value included in the message, a call to the third party technology application programming interface including the parameter,
wherein causing the function of the third party technology application programming interface to be called comprises using the formatted call to call the function of the third party technology application programming interface.

16. The apparatus of claim 10, wherein the at least one processor is configured to cause the apparatus to further perform:
maintaining state information for at least one interaction with the third party technology application programming interface generated in response to one or more calls from the user application; and
managing interactions between the user application and the third party technology application programming interface via the one or more message queues based at least in part on the state information.

17. The apparatus of claim 10, wherein the at least one processor is configured to cause the apparatus to further perform:
responsive to the function of the receiving information from the third party technology being called, receiving information from the third party technology application programming interface;
enqueueing a second message in a message queue selected from the one or more message queues, the second message including an indication of the information received from the third party technology application programming interface;
dequeueing the second message; and
informing the user application of the information received from the third party technology application programming interface.

18. The apparatus of claim 10, wherein the database comprises an Oracle database, and wherein Oracle Streams is used to implement the one or more message queues.

19. The apparatus of claim 10, wherein the apparatus further comprises at least one memory storing computer program code, wherein the at least one memory and stored computer program code are configured, with the at least one processor, to cause the apparatus to at least perform:
enqueueing, in a message queue selected from one or more message queues implemented in a database, a message including an indication of a function of a third party technology application programming interface corresponding to a call from a user application;
dequeueing the message from the selected message queue; and
causing, based at least in part on the indication included in the dequeued message, the function of the third party technology application programming interface to be called.

20. A computer program product comprising at least one non-transitory computer-readable storage medium having computer-readable program instructions stored therein, the computer-readable program instructions comprising:
program instructions configured to enqueue, in a message queue selected from one or more message queues implemented in a database, a message including an indication of a function of a third party technology application programming interface corresponding to a call from a user application;
program instructions configured to dequeue the message from the selected message queue; and
program instructions configured to cause, based at least in part on the indication included in the dequeued message, the function of the third party technology application programming interface to be called.
